(19) United States
(12) Patent Application Publication
(10) Pub. No.: US 2006/0164837 A1
(43) Pub. Date: Jul. 27, 2006

(54) Construction of lampshades

(76) Inventor: Bassey B. Utip, London (ES)

Correspondence Address: DAVID A. GUERRA;INTERNATION PATENT GROUP, LLC, 10TH FLOOR, 610 8TH AVENUE S.W., CALGARY, AB, T2P 1G5, CA

(21) Appl. No.: 10/524,132

(22) PCT Filed: Aug. 18, 2003
(86) PCT No.: PCT/GB03/03622

§ 371 Date: Feb. 7, 2005

(30) Foreign Application Priority Data
Aug. 23, 2002 (GB) 0219717.6

(51) Int. Cl. F21V 7/00

(52) U.S. Cl. 362/307

(57) ABSTRACT

A lampshade comprises a plurality of panels (28) joined to one another edge to edge. Each panel is formed of a laminate comprising a relatively stiff substrate material (33) and an overlying relatively flexible decorative layer (36). At each join between adjacent panels, the flexible layer (36) of at least one of the panels (28) extends beyond the edge of the substrate to form a loose flap that serves to conceal the edge of the substrate material (33).

### FIELD OF THE INVENTION

The present invention relates to a hollow body. Though the hollow body could be used for various purposes, for example as a tea cosy or even as a tent, it will hereinafter be referred to for convenience as a lampshade, as this is the primary application for the invention.

### BACKGROUND OF THE INVENTION

Conventionally, lampshades of good quality are manufactured by stretching a fabric, such as silk, over a wire frame so that the fabric totally conceals the wire frame. This method of manufacture is labour intensive and therefore costly to implement.

Several less costly alternative methods of producing lampshades have previously been proposed but none has resulted in a lampshade that compares in quality with, and is as aesthetically appealing as, a fabric stretched over a wire frame.

WO 02/18838 (Sviland) describes a kit for making a frustoconical lampshade where the panels are secured together by rivet-like fasteners through pre-cut registered holes in the panels. Here the fasteners mar the appearance of the lampshade.

GB 633,155 (Page) describes lampshade, that can only be cylindrical or conical made of stiff panels wherein the panels, with their edges abutting and exposed, are secured to slots in a transversely located ring and retained in place with string or tape.

GB 653,645 (Heppel) describes a lampshade, similar in appearance to that of Page, which is made from panels that have slots or holes at each corner of the panel, secured to two specially designed transverse members through the slots, or holes.

GB 1,372,263 (Collins) discloses a further conical or cylindrical shade made from panels where the panels have one slot in each corner by which each panel is clipped to rigid rings that hold them in place with edges abutting.

Page, Heppel and Collins all have limited design possibilities as they can only produce shades which are cylindrical or conical with panels that bow outwards. None can be used to produce a shade resembling a fabric stretched over a wire frame.

GB 322,266 (Gibson) and GB 624,635 (Morris) describe lampshades made from a plurality of panels where the panels have holes along their edges and are laced together with string or similar lacing material through the holes in adjacent panels. In both cases, the appearance of the shade is marred by the clearly visible stitching.

GB 700,348 (Waite), which is believed to represent the closest prior art to the present invention, describes stiff panels that are joined to one another edge to edge. The join between adjacent panels is made by adhering a braid which is also used as decoration along the lower and upper edges of the lampshade. Aside from the cost of the braid, it once again mars the appearance of the lampshade.

### OBJECT OF THE INVENTION

The present invention therefore seeks to provide a versatile lampshade construction that can be used to produce a wide variety of shapes and enables lampshades as aesthetically appealing as those made of a fabric stretched over a wire frame to be manufactured less expensively.

### SUMMARY OF THE INVENTION

According to the present invention, there is provided a lampshade comprising a plurality of panels joined to one another edge to edge, wherein each panel is formed of a laminate comprising a relatively stiff substrate material and an overlying relatively flexible decorative layer and wherein, at each join between adjacent panels, the flexible layer of at least one of the panels extends beyond the edge of the substrate to form a loose flap that serves to conceal the edge of the substrate material.

The substrate should be formed of a material that is capable of being bent to the desired outline of the lampshade but having sufficient rigidity to ensure that the assembled lampshade does not collapse under its own weight.

Conveniently, the substrate may be card, parchment or a plastics material. A preferred plastics material is PET because it has a high working temperature, good tensile strength and good tolerance to ultraviolet rays. A particular type of PET is that sold under the trademark MYLAR and manufactured by DuPont.

The decorative material is typically made of a woven fabric, preferably silk, but it may be made of a non-woven material.

It is possible to use the loose flaps exclusively for the purpose of covering the edges of the substrate material at the joins and to rely on some other means to join adjacent panels to one another. For example, the panels may be joined to one another by an adhesive tape applied to the inner sides of the panels. Alternatively, the side edges may be shaped to interlock mechanically with one another such as by forming interlocking dovetail portions along the mating edges. If positioned on the outside of the lampshade, the dovetail portions can provide an attractive stickleback effect.

It is however preferred for the loose flaps to serve as part of the means that act to secure adjacent panels to one another.

In one embodiment of the invention, adjacent panel edges are butt jointed to one another. This may be achieved by arranging for each panel to have a loose flap that is folded over the edge of the substrate of the same panel, the two loose flaps being secured to one another, such as by sewing.

In an alternative embodiment of the invention, one of the edges at each join may overlap and overlie the other. This may be achieved by providing the edge of only the upper of the two adjacent panels with a loose flap, which is folded twice to cover the edges of the substrates of both panels, and which is secured to the lower panel.

Within the same lampshade, it is possible to use both butt joins and overlapping joins for the different joins and the direction of overlap may either be the same at every join or may alternate around the perimeter of the lampshade.

Loose flaps of the decorative material are also preferably provided along the upper and lower edges of the panels. These can be used solely for concealing the edges of the substrates but they can also be wrapped about wire loops that are used to strengthen the lampshade or as part of the frame for mounting the lampshade on a lamp or light socket.

### BRIEF DESCRIPTION OF THE DRAWINGS

The invention will now be described further, by way of example, with reference to the accompanying drawings, in which:

FIGS. 1A, 1B, 1C and 2 to 7 show different parts and steps in the formation of a first type of lampshade of the present invention in which loose flaps of the flexible material are used in securing the panels to one another and

FIGS. 8 and 9 show a panel and a finished lampshade in which the panels are designed to interlock with one another mechanically.

### DETAILED DESCRIPTION OF THE PREFERRED EMBODIMENTS

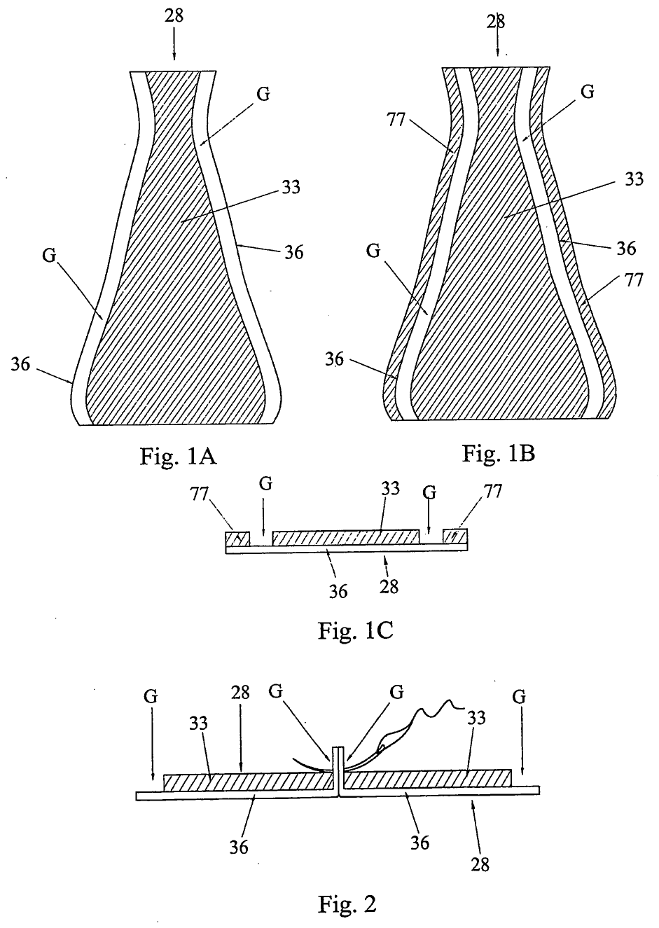

Referring now to FIG. 1-7, there is illustrated the production of a first embodiment of the invention. The embodiment is a lampshade with a substrate which may be card, parchment or a plastics material. A preferred plastics material is PET because it has a high working temperature, good tensile strength and good tolerance to ultraviolet rays. A currently preferred type of PET is that sold under the trademark MYLAR and manufactured by DuPont.

The panel 28 comprises a substrate 33, shown in FIG. 1a, which may be of any desired shape. The panel 28 also comprises a fabric or other flexible material 36 with which the substrate 33 is laminated. A loose flap G, of sufficient size to allow the material 36 to be folded over the edge of the substrate 33 is provided along the side of the laminated substrate 33 to serve for securing adjacent panels to one another and to conceal the edge of the substrate at the joins. The fabric material 36 is cut along the outer edge of the loose flap G. The loose flap G is shown to be of constant width the edge of the substrate 33, but it may be desirable for aesthetic or other reasons to vary its width at points along the edge of the substrate 33. The panel 28 is thus composed of material 36, which is laminated to the substrate 33, with a loose flap G of material 36 along one or more edges of the substrate 33 as shown in FIG. 1A.

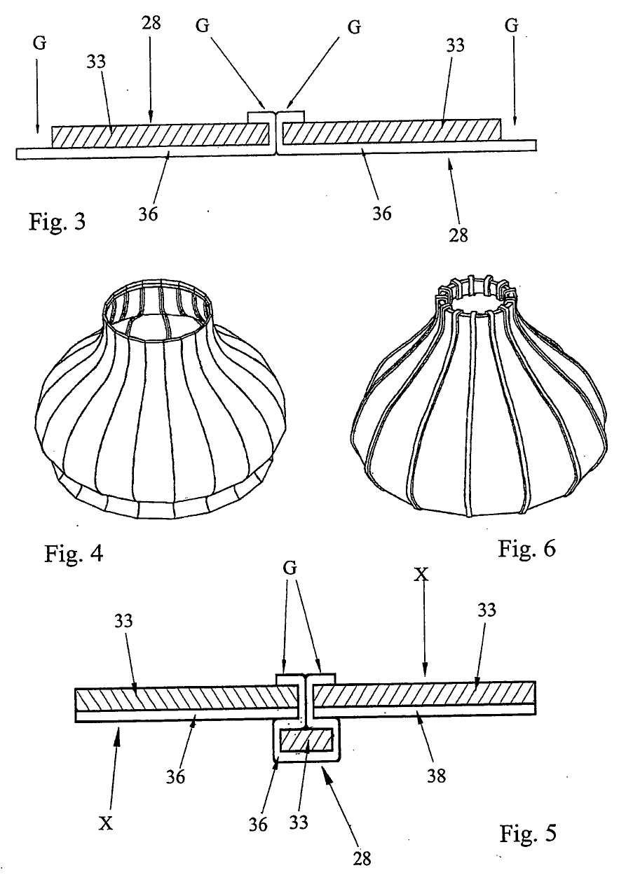

The lampshade shown in FIG. 4 is composed of nineteen of the panels 28. Each panel 28 is attached to its adjacent panel such that the right side of one panel 28 is butt jointed to the left side of the next panel 28 as shown in FIG. 2 with the loose flaps G being pulled through to the interior of the lampshade in between adjacent panels. All panels 28 are secured together, each panel being secured to the adjacent edge of the next panel 28 by stitching, stapling or gluing or taping together their loose flaps. The best result is achieved by the securing point being kept as close as possible to the unlaminated faces of the substrates 33.

The loose flap G of the material 36 on each panel 28 may be secured to the unlaminated reverse face of the substrates 33, such that each substrate 33 is partially enclosed by the material 36 as shown in FIG. 3. This prevents the weave of the material 36 from working loose. However it may be desired to secure the loose flaps from adjacent secured edges together, in pairs, to the same substrate 33 by any suitable means.

The formed lampshade may be secured to a frame or light bulb attachment by any known method or by the provision of a loose flap to the top and/or bottom edge of the panels, whereby the said frame or light bulb attachment is enclosed by the loose flap and secured to the uncovered face of the substrate 33.

FIGS. 1B and 1C show an alternative panel 28 that is composed of a substrate 33 to which is overlaid a fabric or soft material 36. As previously, a loose flap G of the fabric or soft material extends beyond the edge of the substrate 33 but in this case the edge of the loose flap G is provided with a narrow strip 77 of the substrate material that is secured to the fabric or soft material 36. The strip 77 is useful where assembly is by automated machines and flapping materials might present difficulty or a guide is desired for the correct alignment of panels. The strip 77 may be removed from the panel 28 once the panels are secured together.

Alternative configurations in the assembly of the lampshade or other hollow article, using the panel 28, are possible, depending on the desired decorative outcome.

In FIG. 5 there is depicted an alternative manner of securing together the panels 28 so that their edges overlap instead being butt jointed.

Once again such that the edge of the substrate 33 is enclosed by the loose flap G, which is secured to the reverse face of the substrate 33 with adhesive or any other suitable means. The edge of the panel 28 is overlapped onto the edge of an adjacent panel X and the adjacent edge of the overlapped panel X is also enclosed by the loose flap G, which is secured to the underlying face of the overlapped panel X. A completed lampshade of this assemblage is shown in FIG. 6.

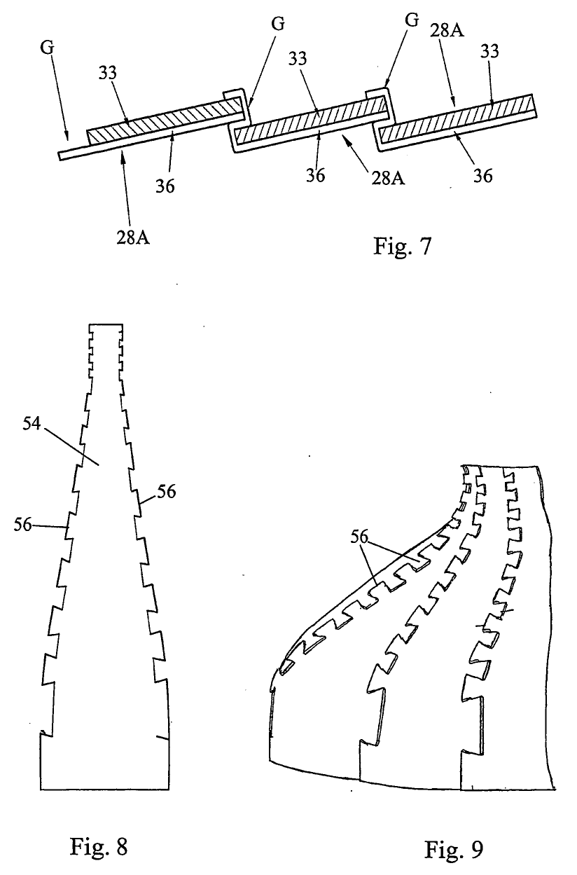

In the lampshade of FIG. 6, there are narrow panels each of which overlies the edges of the two adjacent panels but as an alternative each panel may be designed as shown in FIG. 7 to overlie the next panel along one edge and thereby achieve a stepped configuration. Thus, in FIG. 7 the panels 28A are provided with a loose flap G to one edge and secured to the next panel in the same manner described above. Therefore the number of edges of a panel that need to be formed with a loose flap will depend on the configuration desired, and the panels may be of similar or of dissimilar and unequal shapes.

Referring now to FIGS. 8 and 9, there is shown the production of a second lampshade or other hollow article of the present invention. In this lampshade, the individual panels, shown in FIG. 8, are connected to one another at the top and bottom by any of the method described previously but along the remainder of the length of the side edges the interlock between the panels is purely mechanical. To this end, the side edges have cut-outs that define dovetail portions 56 that slot into one another to form a lampshade having the appearance shown in FIG. 9. The dovetail portions 56 project to give an attractive stickleback effect.

The panel 54 shown in FIG. 8 once again is formed of a laminated sheet that has a stiff substrate and a flexible decorative fabric that extends beyond the edge of the substrate 55.

The substrate is provided with integrally formed dovetail portions 56 along its edge, and a loose flap of the overlying material 57 around the edge of each dovetail portion 56, wherein the flap of material is folded over the dovetail portion 56 to conceal the substrate not only at the edges but also on the reverse side of the dovetail portion 56. The loose flap of material may be secured to the reverse side of the dovetail portion 56 with adhesive or by any suitable method.

The panels 54 are secured together by interlocking the dovetail portions 56 of the adjacent edges of the joined panels 54 such that all dovetail portions 56 appear on the outside of the lampshade as shown in FIG. 9.

It should be noted that though the sections of the substrate between the dovetails 56 have been removed in the illustrated embodiment, they may be retained if desired and when retained they will increase the tension between the joined panels 54 and thereby improve the rigidity of the assembled lampshade. Further, the interlocking portions 56 need not be in the shape of dovetails but may be of any desired shape such as for example part circular or part of an ellipse.

It may also be desirable for the interlocking portions to appear on the inside of the lampshade, in which event, where the interlocking portions are in the shape of dovetails, the loose flap of material G would be provided not to the dovetail portions but to the sections between the dovetail portions.

To improve the rigidity and appearance of the lampshade of all the above described embodiments, a conformal coating may be applied to the inside of the lampshade. Though it is possible to use polyester resin coatings these tend to crack. Preferred coatings are two-part polyurethane based plastics casting resins made by Atlas Polymers Ltd. of Pontypridd, UK and marketed as DR018 or an alternative resin made by Smooth-On Inc., USA and marketed under the trademark CRYSTAL CLEAR. Both coatings have excellent bonding properties, good working temperatures, they do not crack, are water clear and will withstand exposure to ultraviolet light.

However, it is necessary to first seal all joints on the surface of the lampshade to be coated, with adhesive or any other suitable means in order to prevent the resin contacting and staining the fabric.

It should be mentioned that the panels need not have the same shape as one another nor need they all be of the same size. Further, the panels need not extend parallel to the central axis of the lampshade but may spiral at an angle between the top and bottom edges. A still further possibility is that a join may be provided that extends parallel to the top and bottom edges, that is to say a panel extending from the top to the bottom edges of the lampshade may itself be composed of two or more sections joined end to end. In this case, the joins of adjacent panels may be offset from one another to give a brickwork-like effect.

1. A lampshade comprising a plurality of panels joined to one another edge to edge, wherein each panel is formed of a laminate comprising a relatively stiff substrate material and an overlying relatively flexible decorative layer and wherein, at each join between adjacent panels, the flexible layer of at least one of the panels extends beyond the edge of the substrate to form a loose flap that serves to conceal the edge of the substrate material.

2. A lampshade as claimed in claim 1, wherein the substrate is formed of a material selected from card, parchment and a plastics material.

3. A lampshade as claimed in claim 2, wherein the substrate is formed of polyethylene terephthalate (PET).

4. A lampshade as claimed in any preceding claim, wherein the decorative material is made of a woven fabric.

5. A lampshade as claimed in any preceding claim, wherein each loose flap serves exclusively for the purpose of covering the edge of the substrate material at the join.

6. A lampshade as claimed in claim 5, wherein the panels are joined to one another by an adhesive tape applied to the inner sides of the panels.

7. A lampshade as claimed in claim 5, wherein the side edges of panels are shaped to interlock mechanically with one another.

8. A lampshade as claimed in any of claims 1 to 4, wherein the loose flaps serve as part of means securing adjacent panels to one another.

9. A lampshade as claimed in claim 8, wherein adjacent panel edges are butt jointed to one another.

10. A lampshade as claimed in claim 9, wherein each panel has a loose flap that is folded over the edge of the substrate of the same panel and the two loose flaps of the adjacent panels are secured to one another.

11. A lampshade as claimed in claim 8, wherein the edge of one panel at a join overlaps the edge of the adjacent panel.

12. A lampshade as claimed in claim 11, wherein only the upper of the two panels is provided with a loose flap, the flap being folded twice to cover the edges of the substrates of both panels, and being adhered to the lower panel.

13. A lampshade as claimed in any preceding claim, wherein loose flaps of the decorative material are provided along the upper and lower edges of the panels.

14. A lampshade as claimed in claim 13, wherein the loose flaps along the upper and lower edges of the panels are wrapped about wire loops serving to strengthen the lampshade or as part of a frame for mounting the lampshade on a lamp or light socket.

15. A lampshade as claimed in any one of the preceding claims, wherein a conformal coating is applied to the interior of the lampshade.

16. A lampshade as claimed in claim 15, wherein the coating is a polyurethane casting resin.
